(19) United States
(12) Patent Application Publication
(10) Pub. No.: US 2005/0011003 A1
(43) Pub. Date: Jan. 20, 2005

(54) Sling attachment device

(76) Inventor: Philip Nigel Davis, Gloucester (GB)

Correspondence Address: YOUNG & THOMPSON, 745 SOUTH 23RD STREET, 2ND FLOOR, ARLINGTON, VA, 22202, US

(21) Appl. No.: 10/870,948

(22) Filed: Jun. 21, 2004

(30) Foreign Application Priority Data
Jun. 21, 2003 (GB) 0314511.7

(51) Int. Cl. A61G 7/10; F16B 21/09

(52) U.S. Cl. 5/83.1

(57) ABSTRACT

An attachment device for attaching a sling to a hoist, comprises a headed stud and a plate-like clip, the clip having a slot comprising a first portion through which the head 16 of the stud will pass and a second portion through which the head of the stud will not pass, the first portion and/or the head of the stud being so shaped that the head of the stud will only pass through the first portion when the clip is tilted relative to the stud in order to hinder unintentional disengagement of the clip from the stud.

This invention relates to a sling attachment device for attaching a sling to a hoist, particularly but, not necessarily exclusively, an invalid hoist.

It is known to provide an attachment device comprising a headed stud, which is secured to the lifting arm of a hoist, and a plate-like clip, which is connected to a sling. The clip is provided with a slot comprising a first portion through which the head of the stud will pass, a second portion through which the head of the stud will not pass and a passage joining the first portion to the second portion. In order to place the clip on the stud, the first portion of the slot is aligned with the head of the stud. The clip is then placed over the stud and moved relative to the stud until the stem of the stud is disposed in the second portion of the slot. The second portion of the slot receives the stem of the stud with a clearance so that the clip can pivot about the stem. The passage receives the stem of the stud as a friction fit to discourage unintentional movement of the clip from an operative position in which the stem of the stud is disposed in the second slot portion to a disengageable position in which the stem of the stud is disposed in the first slot portion.

However, these known clips occasionally unintentionally disengage from the studs.

GB 2293857A discloses a clip also provided with a slot having first and second portions similar to those referred to above and a passage joining the first portion to the second portion. The passage over at least part of its length has a width which is less than the cross-sectional dimension of the shaft of the stud and the clip has a weakened zone adjacent to each side of the passage so that the clip can deform to allow the shaft of the stud to pass along the passage between the first and second slot portions. This clip proved unsatisfactory because the manufacturing tolerances were hard to hold and this resulted in clips which were often difficult to disengage.

The present invention seeks to provide an improved attachment device which overcomes the aforementioned drawbacks.

### SUMMARY OF THE INVENTION

According to the present invention, there is provided a sling attachment device for attaching a sling to a hoist, the attachment device comprising a headed stud and a plate-like clip, the clip having a slot comprising a first portion through which the head of the stud will pass and a second portion through which the head of the stud will not pass, the first portion and/or the head of the stud being so shaped that the head of the stud will only pass through the first portion when the clip is tilted relative to the stud in order to hinder unintentional disengagement of the clip from the stud.

Preferred and/or optional features of the invention are set forth in claims 2 to 5 inclusive.

The invention will now be more particularly described, with reference to the accompanying drawings.

### BRIEF DESCRIPTION OF THE DRAWINGS

FIG. 1 is a perspective view of part of one embodiment of an attachment device according to the invention; and

FIG. 2 is a plan view of the clip shown in FIG. 1 on an enlarged scale.

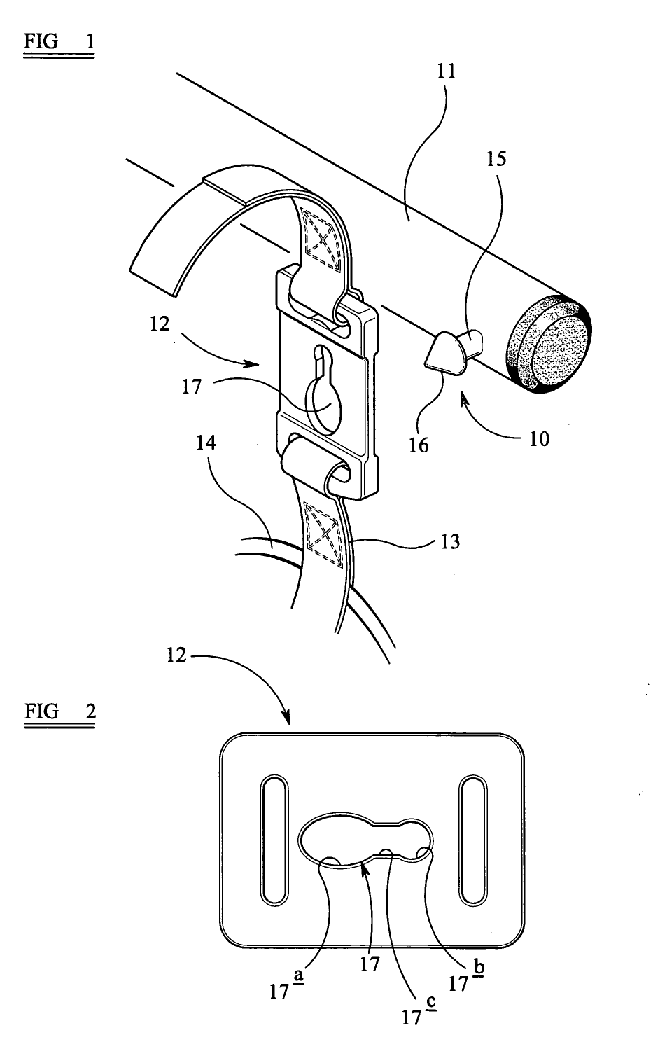

### DESCRIPTION OF THE PREFERRED EMBODIMENTS

Referring to the drawings, the attachment device shown therein comprises a stud 10 secured to a lifting arm 11 of an invalid hoist, e.g. a hoist according to GB 2184706B, and a clip 12 connected by a flexible strap 13 to a sling 14.

The stud 10 has a stem 15 of circular cross section and a round head 16.

The stud head 16 is typically a right circular cone or a right circular frusto-cone to ease engagement with the clip 12.

The clip 12 is plate-like and of generally rectangular shape. It is made of plastics material, typically glass fibre reinforced nylon. The clip 12 has a slot 17 comprising a first part-oval end portion 17a, a second part-circular end portion 17b spaced from the portion 17a, and a neck portion 17c joining the portions 17a and 17b.

The part-oval end portion 17a of the slot has a length which is slightly larger than the diameter of the head 16 of the stud 10, but a width (normal to the longitudinal extent of the slot 17) which is slightly less than the diameter of the head of the stud 10. Thus, in order to engage the clip 12 with the stud 10, it is necessary to tilt the clip 12 relative to the stud 10 and in particular relative to the longitudinal axis of the stud 10. This has the advantage that it will hinder unintentional disengagement of the clip 12 from the stud 10.

Typically, the end portion 17a of the slot 17 is dimensioned relative to the head 16 of the stud 10 so that it is necessary to tilt the clip 12 through an angle of about 15° in order to engage the clip 12 with the stud 10.

The diameter of the slot portion 17b is less than the diameter of the head 16 of the stud and slightly larger than the diameter of the stem 15 of the stud 10 so that when the stem 15 is disposed in the slot portion 17b the clip 12 can pivot freely about the stud 10 but cannot disengage therefrom.

The neck portion 17c of the slot 17 receives the stem 15 of the stud 10 as a friction fit to discourage unintentional movement of the clip 12 from an operative position in which the stem 15 is disposed in the second slot portion 17b to a disengageable position in which the stem 15 of the stud 10 is disposed in the first slot portion 17a. This further hinders unintentional disengagement of the clip 12 from the stud 10.

The longer sides of the slot portion 17a could be chamfered to ease engagement of the clip 12 with the stud 10.

It is to be appreciated that the first end portion 17a of the slot 17 need not be of part-oval shape. It could be of other elongate shape having a length which is greater than the diameter of the head 16 of the stud 10 and a width which is less than the diameter of the head 16 of the stud 10.

Also, the head of the stud could be additionally or alternatively shaped so that it does not pass through what could be a part-circular end portion 17a of the slot 17, unless the clip 12 is tilted relative to the stud 10.

The embodiments described above are given by way of example only and various modifications will be apparent to persons skilled in the art without departing from the scope of the invention.

1. A sling attachment device for attaching a sling to a hoist, the attachment device comprising a headed stud and a plate-like clip, the clip having a slot comprising a first portion through which the head of the stud will pass and a second portion through which the head of the stud will not pass, the first portion and/or the head of the stud being so shaped that the head of the stud will only pass through the first portion when the clip is tilted relative to the stud in order to hinder unintentional disengagement of the clip from the stud.

2. A sling attachment device as claims in claim 1, wherein the head of the stud is of circular cross-section and the first portion of the slot is elongate and has a width which is less than the diameter of the head of the stud.

3. A sling attachment device as claimed in claim 2, wherein the first portion of the slot is of part-oval shape.

4. A sling attachment device as claimed in claim 2, wherein the sides of the slot are chamfered.

5. A sling attachment device as claimed in claim 1, wherein the slot comprises a third portion joining the first and second portions, the third portion being dimensioned to receive the stem of the stud as a friction fit to further hinder unintentional disengagement of the clip from the stud.

6. An invalid hoist having a sling and an attachment device for attaching the sling to the hoist, the attachment device comprising a headed stud and a plate-like clip, the clip having a slot comprising a first portion through which the head of the stud will pass and a second portion through which the head of the stud will not pass, the first portion and/or the head of the stud being so shaped that the head of the stud will only pass through the first portion when the clip is tilted relative to the stud in order to hinder unintentional disengagement of the clip from the stud.
